(19) United States
(12) Patent Application Publication
(10) Pub. No.: US 2017/0323391 A1
(43) Pub. Date: Nov. 9, 2017

(54) PROCESSING APPARATUS HAVING A REFERENCE IDENTIFICATION TIED TO A LOCKED ENTRY

(71) Applicant: Dennis Stong, Draper, UT (US)

(72) Inventor: Dennis Stong, Draper, UT (US)

(21) Appl. No.: 15/662,155

(22) Filed: Jul. 27, 2017

Related U.S. Application Data
(63) Continuation of application No. 14/046,921, filed on Oct. 5, 2013, now abandoned.
(60) Provisional application No. 61/711,034, filed on Oct. 8, 2012.
(60) Provisional application No. 61/710,538, filed on Oct. 5, 2012.

(51) Int. Cl. G06Q 40/00

(52) U.S. Cl. CPC G06Q 40/10; G06Q 40/12; G06Q 40/125

(57) ABSTRACT

Systems, methods, and non-transitory computer-readable mediums storing computer program code implement methods for providing a computer-aided dual-date system and method for accounting. In some cases, the described systems and methods include steps of receiving a plurality of accounting transactions to a computer device, storing the plurality of accounting transactions, and utilizing the plurality of stored accounting transactions to generate a financial statement. In some cases, each accounting transaction includes two dates, namely a transaction date and an accrual date, wherein the accrual date is for any part of the transaction that is linked to an income statement account. In some cases, the accrual date, unlike the transaction date, may be different for each part within the transaction, indicating when the individual parts of the transaction accrued. Inclusion of the dual dates for each transaction can facilitate generation of accounting reports and statements and other accounting duties.

### CROSS-REFERENCE TO RELATED APPLICATION

This application is a continuation of U.S. patent application Ser. No. 14/046,921 (Attorney Docket No. 9250.21), filed Oct. 5, 2013, entitled “DERIVED FINANCIAL REPORTING USING MULTIPLE DATES WITHIN A SINGLE TRANSACTION TO ALLOW FOR OMISSION OF JOURNAL ENTRIES,” which claims priority to U.S. Provisional Patent Application Ser. No. 61/710,538 (Attorney Docket No. 9250.12), filed Oct. 5, 2012, entitled “SYSTEMS AND METHODS FOR PROVIDING COMPUTER-AUTOMATED ADJUSTING ENTRIES” and to U.S. Provisional Patent Application Ser. No. 61/711,034 (Attorney Docket No. 9250.20), filed Oct. 8, 2012, entitled “SYSTEMS AND METHODS FOR PROVIDING COMPUTER-AUTOMATED ADJUSTING ENTRIES,” the entire disclosures of which are incorporated herein by reference.

### BACKGROUND OF THE INVENTION

### 1. Field of the Invention

The present invention relates to accounting processes, and more particularly to a computer-automated adjusting entries system.

### 2. Background and Related Art

Many current accounting systems and processes utilize a single transaction date. In this regard, such systems and processes often require numerous general journal entries to produce accrual-based financial statements. As a result, these systems and processes often lend themselves to errors and estimates that do not always capture data accurately. Additionally, such systems and processes can be difficult to audit due to different interpretations and narratives that may change between individuals.

Accounting systems regularly utilize transactions affecting two types of accounts: (i) income statement accounts, which include all accounts normally found on the income statement, such as income, expense accounts, cost of goods sold accounts, etc., and (ii) balance sheet accounts, which are all other types of accounts, such as asset, liability, and equity accounts, etc. According to most established accounting principles, all transactions must be balanced to be valid—meaning the sum of all debits and the sum of all credits within a transaction must be equal. For instance, if a check is written withdrawing $100 in funds from a bank account (an example of balance sheet account), and the $100 is used to buy $78 in paper and pens (office supplies, an example of an expense account) and $22 in stamps (postage, another example of an expense account), the transaction is balanced as $100=$78+$22.

Some conventional accounting systems utilize certain financial statements to sum all transactions. These financial statements are often known as an income statement and a balance sheet. When all transactions are properly balanced according to established accounting principles, then the income statement and balance sheet should also be in balance. To balance the income statement and balance sheet, one entry is carried over from the income statement to the balance sheet, namely net income. Prior net incomes from any periods before the date span in review are carried over to the balance sheet as retained earnings.

As a general rule, any properly-configured accounting system must sum the net income from the income statement and the retained earnings and add them to the balance sheet. The addition of these two summation entries that currently exist in accounting to the balance sheet ensures that all parts of the transactions are accounted for and balanced. If all transactions are balanced, then a business' assets equal its liabilities plus the owner's equity. If, however, the business' assets do not equal the business' liabilities plus the owner's equity, then there is at least one transaction not in balance, or there is a problem with the accounting system or software.

While accounting systems and processes are available, challenges still exist. Accordingly, it would be an improvement in the art to augment or even replace current techniques with other techniques.

### BRIEF SUMMARY OF THE INVENTION

Some implementations of the invention provide systems, methods, and non-transitory computer-readable media for storing computer program code for implementing methods for providing a computer-aided dual-date method for accounting. In at least some instances, the computer-aided dual-date method for accounting includes steps of receiving a plurality of accounting transactions to a computer device, storing the plurality of accounting transactions at the computer device, and utilizing the plurality of stored accounting transactions to generate one or more financial statements.

In some implementations, all accounting transactions have a transaction date, which is consistent for all parts of the transaction. In addition to the transaction date, in some implementations of the described systems and methods, all parts of a transaction that are related to accounts normally found on the income statement, such as an “income” or “expense” account (of virtually any suitable type), also have an accrual date. This accrual date, unlike the transaction date, may be different for each part within the transaction, indicating when the individual parts of the transaction accrued. In at least some implementations of this invention, the inclusion of the dual dates (e.g., transaction and accrual dates) for each transaction greatly facilitates generation of accounting reports and statements and other accounting duties.

In some cases, each transaction comprises multiple different parts detailing the different components within a transaction. For example, a company writes a check for $100 to pay for $78 in office supplies and $22 in stamps. In this example, the $100 check to withdraw funds from the checking account is one part, the $78 expense for the office supplies is another part, and the $22 expense for stamps is yet another part. Together the various parts make up one transaction. In order to balance the transaction in this example, the $100 check to withdraw funds is recognized as a credit and the allocation to the expense accounts for $78 in office supplies and $22 in stamps are both recognized as debits. Thus, the sum of the debits ($78+$22) is equal to the sum of the credits ($100), and the transaction is considered to be in balance.

While the methods and processes of the present invention may be particularly useful in accounting software, those skilled in the art will appreciate that the described methods and processes can be used in a wide variety of different applications and in a variety of different products and services.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a depiction of an illustrative computer system suitable for use with some embodiments of the invention;

FIG. 2 shows a depiction of an illustrative networked computer system suitable for use with some embodiments of the invention;

FIG. 3 shows a representative depiction of transactions according to some existing accounting methodologies; and

FIG. 4 shows a representative depiction of a dual-date transaction illustrating features of some embodiments of the invention

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims. Additionally, references throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

According to some current accounting methods, all account types are categorized into two categories, namely: (i) income statement accounts (which can include all the account types that are summed by account on the income statement, including, cost of goods sold, other income, other expense, etc.) and (ii) balance sheet accounts. The “income statement” is a common report, also referred to as the “profit and loss” statement. It can have other names, but they may all be included as meaning any type of account which is used to designate parts that increase the net income or that decrease the net income, regardless of what the actual summation report is called. References throughout this document to income statement account, income statement accounts, or similar language may refer to these types of accounts. Additionally, the term balance sheet accounts may refer to those types of accounts that are not normally found on the income statement report. Moreover, the term balance sheet account may also be used herein to refer to any type of account that is used to designate parts that do not either increase or decrease the net income. Examples of these can include bank accounts, liability accounts, etc. Additionally, references herein to balance sheet account, balance sheet accounts, and similar language may simply refer to these types of accounts. Often, a typical transaction includes account types from each category.

The following disclosure is grouped into three subheadings, namely “SYSTEMS AND METHODS,” “EXAMPLES,” and “OPERATING ENVIRONMENTS.” The utilization of the subheadings is for convenience of the reader only and is not to be construed as limiting in any sense.

### Systems and Methods

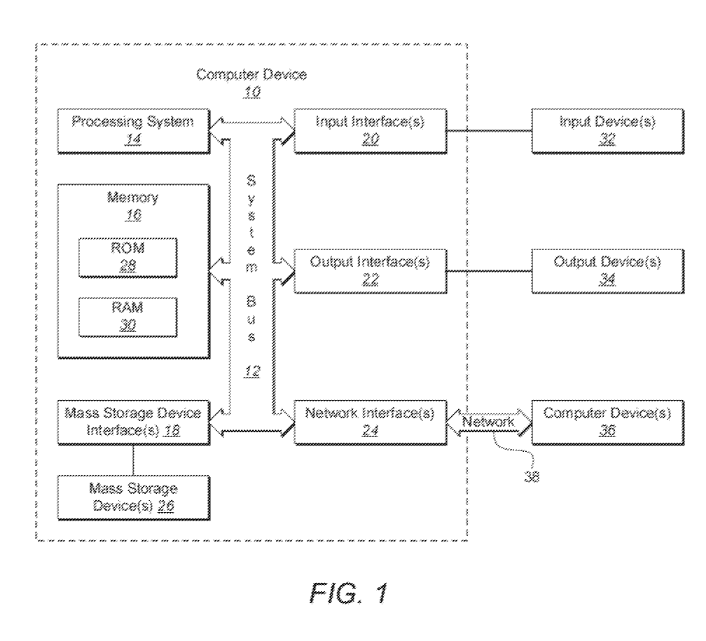

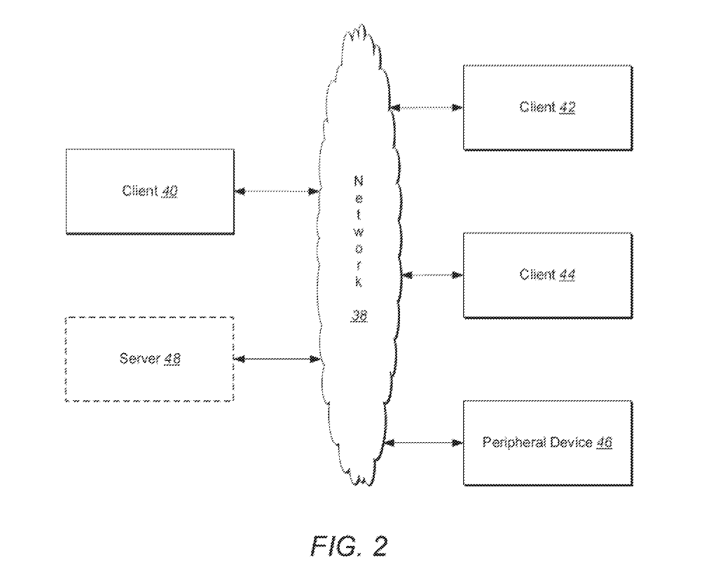

One skilled in the art will appreciate that embodiments of the invention may be practiced by one or more computing devices and in a variety of system configurations, including, without limitation, in a networked configuration. In this regard, FIG. 1 and the corresponding discussion are intended to provide a general description of a suitable operating environment in which representative embodiments of the invention can be implemented. FIG. 2 and the corresponding discussion are intended to provide a representative networked computer system suitable for use with some representative embodiments of the invention. A detailed discussion of FIGS. 1-2 will be provided below.

The present invention relates to accounting processes, and more particularly to a computer-automated adjusting entries system. Indeed, some embodiments of the present invention provide systems, methods, and computer-readable media (e.g., non-transitory computer-readable media) storing computer program code for implementing methods for providing a computer-aided dual-date method for accounting. In at least some implementations, the described computer-aided dual-date method for accounting includes steps of receiving one or more accounting transactions to a computer device, storing the accounting transactions at the computer device, and utilizing the stored accounting transactions to generate one or more financial statements. In some embodiments, each of the accounting transactions includes a transaction date, which is consistent for each of the parts of the transaction. Additionally, in some embodiments, each part of a transaction that is related to an income statement account includes an accrual date. In this regard, the accrual date (unlike the transaction date) can be different for each part within the transaction. In at least some embodiments, the inclusion of the accrual date for each part of the transaction assigned to an income statement account within the transaction can greatly facilitate generation of accounting reports and statements and other accounting duties.

One method of accounting utilizes a single date per transaction which may be assigned an identifier, such as a [Transaction Date], which will be used herein to facilitate the current discussion. Other similar identifiers used herein will, in some cases, immediately follow the generic term to which they apply and will be used in the discussion herein for clarity, but it should be understood that the use of such identifiers is merely illustrative for purposes of the disclosure of embodiments of the invention. In some cases, the [Transaction Date] is the actual date on which a transaction occurred, the date on which the transaction is being recorded, a date of awareness of the transaction, and/or any other suitable date. In some (if not all) cases, each transaction is balanced, such that the sum of all debit amounts equals the sum of all credit amounts within the transaction.

In some embodiments of the described dual-date accounting methodology, each transaction has a

[Transaction Date] (which, as described above, may be the actual date on which a transaction occurred, the date on which the transaction is being recorded, a date of awareness of the transaction, and/or any other suitable date) and each part within a transaction that is linked, or otherwise assigned to, an income statement account also includes an accrual date [Accrual Date], which can be 1) an actual date to which the transaction (or part of the transaction, e.g., expense, income, etc.) relates, 2) an accounting period to which the transaction (or part of the transaction) relates, and/or 3) any other suitable date. In this regard, the term accounting period may be used herein to refer to any suitable block of time (e.g., day, week, two-week period, quarter, six-month period, year, etc.) designated by the user of accounting systems which serves as a reference for review. For example, if a business likes to review its accounts on a monthly basis, then the start date of a given period would be the first day of that given month and the end date of that period would be the last day of the same month. Often, accounts are reviewed on an annual basis as well, which would make the start date of a given period be the first day of the year and the end date would be the last day of that year. In any case, the scope of the described systems and methods is not limited to any type of period utilized by the user.

Closing is another common occurrence with almost any accounting system. In this regard, in most, if not all, single-date accounting systems, the closing of a period does not require the closing date to be recorded—at least not in an accessible location within the accounting system. Instead, to close a given period under some conventional methods, an accountant or bookkeeper manually adds the entries, which can overlap the periods, and creates general journal entries, as appropriate. In such single-date accounting systems, the closing date can be recorded (if at all), in a written notebook or another form of media, for example, and not necessarily within an electronic or other storage media associated with the accounting system In any case, the term closing date may be used herein to refer to the date when the records are closed for a given period.

In some embodiments, closing with an accounting system utilizing the described dual-date accounting methodology does require that the closing dates for each period be recorded in an accessible registry, table, database, electronic file, and/or other suitable storage location in order for the computer system to properly accumulate (or sum) the entries on financial statements. In this regard, the terms entry, entries, and similar language may be used herein to refer (on a financial report) to the summation and/or placement of that summation into a particular line or position on a financial report. Additionally, the term placement may be used herein to refer to the creation of a new line or the addition to an entry that is already there.

When closing occurs utilizing a system which utilizes embodiments of the dual-date accounting methodology described herein, closing is typically one step, and the period end date and the closing date are recorded, such as in a table, database, and/or other suitable location. Additionally or alternatively, period end dates and closing dates can be pre-entered, such as in a table or other suitable location, and can be used thereafter. In some cases, the accounting period closing dates when ordered by the period end dates are sequential, meaning that the closing date for a prior period does not come after the closing date for a subsequent period. In some instances, a period is considered closed if the closing date for that period has occurred, meaning that it is not in the future. Additionally, in some instances, any dates that fall after the latest period end date (or which relate to a period with a closing date that is still in the future) are considered to be part of the “open” period.

When analyzing accounting information, the “period of interest” referred to herein represents the period of time to which a particular financial statement is directed. It could be the period most-recently closed, any other closed period, or could refer to the most-recent period which is not yet closed. In this regard, the “period of interest” can be any suitable period designated by the user. Moreover, in some embodiments, the desired “period of interest” has both a period start date and a period end date. In some embodiments, to create financials with proper accruals for closed periods, the “period of interest” has start and end dates that correspond to the related closing dates. Similarly, the “prior period” is typically viewed as the period that ends the day before the period of interest begins.

In some embodiments, accrual-based financials are derived using the described dual-date accounting methodology, without requiring any general journal entries (such as to accrue income or expenses into a period other than the one designated by the transaction date, etc.). Instead, a computer system uses the data (e.g., the Transaction Date and any Accrual Dates) associated with the recorded transactions, the recorded period of interest closing date (if that period is closed), the recorded prior period closing date, the period of interest start date, and the period of interest end date to provide the needed financial statements.

As with many existing accounting systems, the dual-date accounting systems and methods as disclosed herein can be used to generate any of a variety of financial statements, and such systems and methods are particularly useful for providing accrual-based financial data. Any financial statements that use accrual-based income statement or balance sheet accounts as their basis, such as the income statement, balance sheet, statements of cash flows, or even cash based financial statements, and the like can be derived by first deriving the accrual-based financials, as disclosed herein, and by then making any desired adjustments to those accounts following currently accepted accounting methods.

In some cases, the conventional method for generating financial statements utilizing a single date is as follows: The income statement is generated by summing the parts of transactions linked to an income statement account and which have a [Transaction Date] within the period of interest. The balance sheet is generated by summing the parts of transactions linked to a balance sheet account with [Transaction Dates] on or before (but not after) the period of interest's end date. In addition, some such conventional systems also create automated accumulation entries for the income statement account transactions in order for the balance sheet to balance. In some cases, these automated entries are not accumulated (or summed) by account, but instead are summed up and entered as follows: Income statement account transaction entries for the period of interest are summed up and entered as “Net Income”, income statement account transaction entries prior to the period of interest are summed up and entered as “Retained Earnings”. Once the balance sheet is in balance, however, an accountant or someone knowledgeable about accounting is then required, as appropriate, to manually maneuver the various entries from one area into another, generating values such as “payroll payable”, “prior period adjustments”, “unearned revenue”, etc. This maneuver is normally accomplished through the use of general journal entries.

In some embodiments, the dual-date accounting method as described herein does not require such general journal entries. Instead, in some such embodiments, the income statement is derived by summing by account the parts of transactions linked to income statement accounts that have an [Accrual Date] within the period of interest and a [Transaction Date] that is on or before (but not after) the closing date of the period of interest. In this regard, the balance sheet is generated by summing by account the parts of transactions linked to a balance sheet account that have a [Transaction Date] no later than the period of interest end date. In addition, in some embodiments, a system performing the described dual-date method is able to generate automated accumulation entries on the balance sheet, which represent the sum of all the parts of transactions linked to income statement accounts pertinent to such a report in order for the balance sheet to balance. In some embodiments, these automated entries are not accumulated by account, but instead are summed up and entered as various entries, such as “Net Income”, “Retained Earnings”, etc. In some embodiments, these entries are also summed with the net results being added to existing entries in those prospective accounts. In some cases, this is done through an automated-system-generated entry by a computer or other such device.

As will be appreciated, a variety of accounts to which accumulation and adjustment entries are assigned can vary according to each business' circumstances. As a result, the particular accounts described herein should be viewed only as illustrative and not as being restrictive in any manner. Additionally, the number of accounts to which the various accumulation and adjustment entries can be assigned can be greater or fewer than those described herein, as applicable. It should also be recognized that naming conventions can vary from those used in the listed examples, and that the provided examples are not exhaustive of potential adjusting entries and other mechanisms that can be used by accountants or software engineers using the dual-date method and system described herein. Some embodiments and examples of accumulation entries utilizing the described dual-date accounting methodology are described below.

In some embodiments of the described invention, the various parts of a transaction assigned to balance sheet accounts are summed to their respective accounts on the balance sheet with a [Transaction Date] on or before the period of interest's end date. In some such embodiments, such transaction parts have a [Transaction Date], but do not have an [Accrual Date]. In some cases, the terms summing and summed, as referenced here and throughout this document, refer to summing the difference between debit and credit amounts in a particular transaction in its entirety.

In some embodiments, the parts of a transaction linked to income statement accounts are required to have an [Accrual Date] (which can be specific to each individual part of the transaction) as well as the [Transaction Date] (which can be consistent for all parts of the transaction). These transactions are accumulated on the balance sheet in accordance with the conditions shown in Table 1.

To provide a better understanding of Table 1 (as well as the described systems and methods), several definitions are provided herein. In this regard, the term period of interest closing date may be used herein to refer to the date entered into a computer system performing the described methods, wherein such date designates when the period of interest (as described above) has closed. As used herein, the term prior period closing date” may refer to the date entered into the system which designates when the period immediately before the period of interest has closed. As used herein, the term relevant transaction date may refer to transaction dates which are on or before the period of interest's closing date. In this regard, it should be noted that, in some embodiments, if the period of interest does not have a period of interest closing date, then it is omitted from the criteria. As used herein, the term before period may refer to any suitable date before the period of interest has begun. As used herein, the term within period may refer to any suitable date between the start date of the period of interest and the end date of the period of interest, including both the start date and the end date. Additionally, as used herein, the term after period may refer to any suitable date that is after the period of interest's end date.

In accordance with some embodiments of the invention, the following Table 1 illustrates how parts of transactions linked to an income statement account with different [Accrual Dates] and [Transaction Dates] are summed on the balance sheet. In Table 1, the terms “prior period adjustment”, “subsequent period adjustment”, and “other payables” do not represent any particular account. Instead, the particular accounts in which these entries are accrued can be any type of account, as long as they are a balance sheet account.

TABLE 1

| | | Automated Balance Sheet Accruals | | | | |
|---|---|---|---|---|---|---|
| | | | Prior | Subsequent | | |
| | | Net | Period | Period | Retained | Other |
| Accrual Date | Relevant Transaction Date | Income | Adjustment | Adjustment | Earnings | Payables |
| Before Period | Before Period | | | | x | |
| Before Period | Within Period but before Prior | | | | x | |
| | Period Closing Date | | | | | |
| Before Period | Within Period but after Prior | | x | | | |
| | Period Closing Date | | | | | |
| Before Period | After Period | | x | | | x |
| Within Period | Before Period | x | | | | |
| Within Period | Within Period | x | | | | |
| Within Period | After Period | x | | | | x |
| After Period | Before Period | | | x | | |
| After Period | Within Period | | | x | | |
| After Period | After Period | | | | | |

With respect to accumulation and adjustment entries on the balance sheet related to a period of interest (e.g., net income [Net Income]), Table 1 shows that the [Net Income] accumulation entry, in at least some embodiments, is calculated as the total (or sum) of all parts of transactions linked to an income statement account with an [Accrual Date] falling within the period of interest and having a [Transaction Date] on, before, or after the closing date for the period of interest. Thus, Table 1 shows that, in some cases, the [Transaction Date] occurs before the period of interest, within the period of interest, or after the period of interest, but not after the period of interest's closing date. In some cases, this accumulation entry is normally recorded on the balance sheet as “net income” or under a similar term.

In some embodiments, Table 1 shows the prior period adjustment entry is derived as the sum of all parts of transactions linked to an income statement account having an [Accrual Date] prior to the period of interest and a relevant [Transaction Date] occurring either within the period of interest, but after the prior period closing date or after the period of interest. In some cases, this adjustment is normally recorded on the balance sheet as a “prior period adjustment” (or under another similar term).

With respect to accumulation and adjustment entries on the balance sheet related to parts of transactions linked to an income statement account with an [Accrual Date] that is After Period (or later than the period of interest's end date, e.g., a future period), yet recorded with a [Transaction Date] before or within (but not after) the period of interest's end date, these “Subsequent Period Adjustments” (as shown in Table 1) may have a variety of names and be distributed based on a variety of circumstances. For example, a prepaid expenses [Prepaid Expenses] adjustment may be derived by accumulating all parts of transactions that are related to [Expense Account] including all various forms of expense accounts (i.e., cost of goods sold, etc.). Such transactions may be summed with the net result added to the [Prepaid Expense] account as a dynamic computer-system-driven adjusting entry. An unearned revenue [Unearned Revenue] account entry may be derived by summing all parts of transactions that are related to [Income Account], including all various forms of income accounts (i.e., “Other Income”, etc.). Such transactions may be summed with the net result added to the [Unearned Revenue] account as a dynamic computer-system-driven adjusting entry. “Depreciation Expense” could be accrued back to the related contra asset account of “Accumulated Depreciation”.

With respect to accumulation and adjustment entries on the balance sheet related to a prior period (e.g., a retained earnings [Retained Earnings] account), Table 1 shows that, in some embodiments, the [Retained Earnings] accumulation entry for example is calculated as the total of all parts of transactions linked to an income statement account with an [Accrual Date] prior to the period of interest start date and with a [Transaction Date] on or before (but not after) the prior period closing date. In some cases, this accumulation entry is often recorded on the balance sheet as “retained earnings” (or under a similar term).

With respect to accumulation and adjustment entries on the balance sheet related to entries related to the period of interest yet recorded in a future period but not after the period of interest's closing date, Table 1 shows that [Other Payables] accumulation and adjustment entries may be derived as all parts of transactions linked to an income statement account with an [Accrual Date] prior to or equal to (e.g., on or before) the period of interest's end date and having a [Transaction Date] after the period of interest's end date but not after the period of interest's closing date. This adjustment does not necessarily have to be summed to any particular account, such as “Other Payables”, but may be summed to any other balance sheet account, such as: “payroll payable” [Payroll Payable], which has the same date filters, but is limited to transaction types indicative of a paycheck; an “accounts payable” [Accounts Payable] adjustment entry, which uses the same date filters but is limited to transaction types indicative of a bill; another accounts payable [Other Accounts Payable] adjustment entry that uses the same date filters, but with a transaction type that is not a paycheck, bill, or invoice; an accounts receivable [Accounts Receivable] adjustment entry that utilizes the same date filters, but with a transaction type that indicates an invoice; and/or any other suitable adjustment entry.

To facilitate a better understanding of the described dual-date methodology and the benefits to be provided by such methodology, it may be helpful to compare components of a transaction according to a conventional accounting methodology, with components of a transaction according to embodiments of the present invention. According to a conventional single-date, double-entry accounting methodology, a transaction consists of various components. Each component typically has a single date, a debit amount, a credit amount, an account, and a transaction type. Additionally, in such a conventional methodology, the sum of all debit amounts and credit amounts of all components must be equal within a transaction. Also, the single-date “date” is the same for all components.

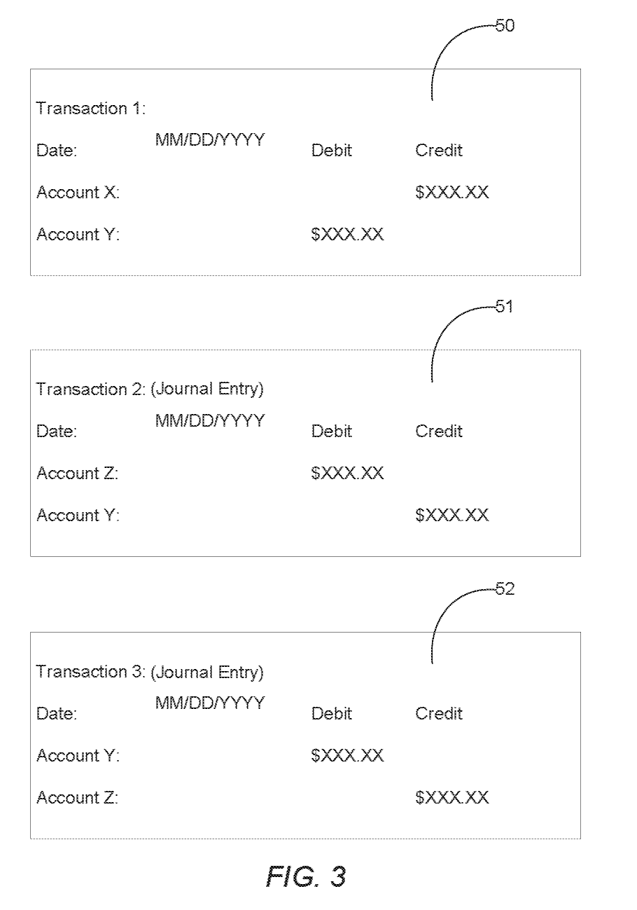

FIG. 3 illustrates an example under a conventional methodology for entering a transaction and the two additional journal entries required to carry back those expenses into a prior period. In this example, as part of Transaction 1, a business writes a check 50 on MM/DD/YYYY (e.g., 1/9/2011) for office supplies. This check was payment for office supplies used in 2010. Additionally, in this example, the accountant wants to recognize the expense of check 50 as a 2010 expense. Accordingly, FIG. 3 shows examples of two journal entries 51 and 52 that are required to make this happen and accrue the expense to the previous year.

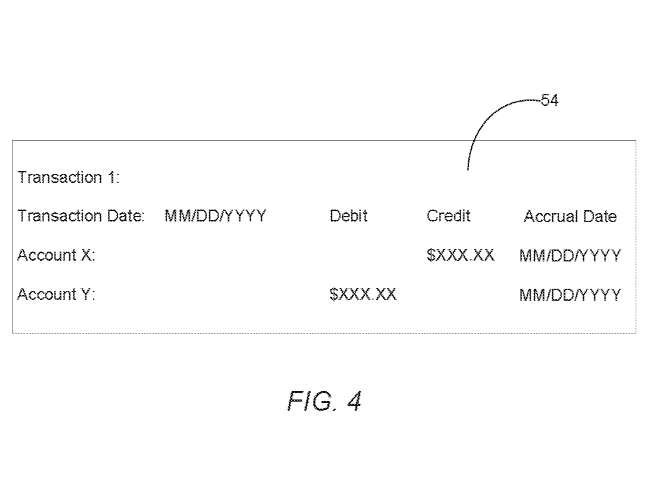

In contrast with the described conventional methods, in some embodiments of the current invention, journal entries or transactions include the [Transaction Date], which (in some embodiments) is the date the transaction occurred and may have nothing to do with the period to which the transaction belongs, and the [Accrual Date], which (in some embodiments) is the period, period date, and/or reference date to which that transaction part should be accrued to, as illustrated in FIG. 4. A transaction according to some embodiments of the invention also includes elements similar to transactions according to traditional methods including a debit [Debit], a credit [Credit], an account [Account], and/or a transaction type [Transaction Type]. That said, where some current methods require three transactions (e.g., the first transaction (or check 50) and the first 51 and second 52 journal entries (as shown in FIG. 3)), FIG. 4 shows that some embodiments of the invention utilize only a single transaction 54 to permit proper accrual and accounting of funds. Indeed, in some embodiments, with that single transaction and the methodologies described above, an expense is able to be realized on at one point in time (e.g., 1/9/2011), yet also be accrued into an earlier time period (e.g., 2010). Moreover, FIG. 4 shows that (in some embodiments) this is done without any additional transactions or manipulation of the data through general journal entries.

In some embodiments, when an asset is purchased or acquired within a given transaction, the described systems and methods will also create, in a single transaction, all of the depreciation expense entries required for the asset to be fully depreciated. In this regard, the accrual date for those parts of the transaction will be in the period to which the expense belongs. Additionally, in some cases, the system will further create an [Accumulated Depreciation] entry, which is equal to the entire amount being depreciated. In at least some embodiments, the [Depreciation Expense] that occurs after the period of interest will be accumulated to [Accumulated Depreciation].

The following is an example showing the depreciation of an asset in accordance with a conventional method and some embodiments of the described methodologies. In this example, a company purchases a new phone system from “X2 Phone Systems” on Jun. 4, 2011 for $112,000. The company then chooses to depreciate the asset over the next five years, starting on 12/31/11.

The following represents how that transaction might be entered utilizing a conventional accounting methodology. In this regard, it is noted that general journal entries are typically utilized to allocate the appropriate depreciation to the appropriate period.

Transaction in Accordance with a Conventional Technique

| | | Transaction | | | |
|---|---|---|---|---|---|
| Line | Type | Date | Account | Debit | Credit |
| 1 | Check | Jun. 4, 2011 | EveryWhere BankCorp- | | 112000 |
| | | | Checking | | |
| 2 | | Jun. 4, 2011 | Phone System (Asset | 112000 | |
| | | | Account) | | |
| 3 | Journal | Dec. 31, 2011 | Depreciation Expense | 22400 | |
| 4 | | Dec. 31, 2011 | Accumulated Depreciation | | 22400 |
| 5 | Journal | Dec. 31, 2012 | Depreciation Expense | 22400 | |
| 6 | | Dec. 31, 2012 | Accumulated Depreciation | | 22400 |
| 7 | Journal | Dec. 31, 2013 | Depreciation Expense | 22400 | |
| 8 | | Dec. 31, 2013 | Accumulated Depreciation | | 22400 |
| 9 | Journal | Dec. 31, 2014 | Depreciation Expense | 22400 | |
| 10 | | Dec. 31, 2014 | Accumulated Depreciation | | 22400 |
| 11 | Journal | Dec. 31, 2015 | Depreciation Expense | 22400 | |
| 12 | | Dec. 31, 2015 | Accumulated Depreciation | | 22400 |

In contrast, some representative embodiments of the present invention record the entries as a single transaction. Thus, the following shows an example of how the asset purchase and depreciation might look using a representative embodiment of the present invention. Also, as shown below, in some cases, the entry remains unchanged, regardless of closing scenarios.

Transaction in Accordance with Some Embodiments of the Current Invention

| | | Transaction | Accrual | | | |
|---|---|---|---|---|---|---|
| Line | Type | Date | Date | Account | Debit | Credit |
| 13 | Check | Jun. 4, 2011 | | EveryWhere BankCorp-Checking | | 112000 |
| 14 | | Jun. 4, 2011 | | Phone System (Asset Account) | 112000 | |
| 15 | | Jun. 4, 2011 | | Phone System - Accumulated Depreciation | | 112000 |
| 16 | | Jun. 4, 2011 | Dec. 31, 2011 | Depreciation Expense | 22400 | |
| 17 | | Jun. 4, 2011 | Dec. 31, 2012 | Depreciation Expense | 22400 | |
| 18 | | Jun. 4, 2011 | Dec. 31, 2013 | Depreciation Expense | 22400 | |
| 19 | | Jun. 4, 2011 | Dec. 31, 2014 | Depreciation Expense | 22400 | |
| 20 | | Jun. 4, 2011 | Dec. 31, 2015 | Depreciation Expense | 22400 | |

To provide a better understanding of the described dual-date methodology and the benefits provided thereby, an additional example relating to reporting is included herein. There are many different reports utilized in general accounting practices. However, two standard reports are the

“Income Statement” (sometimes also referred to as the “Profit/Loss Statement”) and the “Balance Sheet”. In this regard, virtually any general accounting system must be able to produce these two reports. In some cases, to assist in the creation of these reports is a sample list of transactions that a user of any accounting system may enter. In some instances, the reports that follow and are generated based on these transactions. Indeed, in some cases, the reports list the account, the amount, and which lines within the transactions were utilized to gather the information for the report. The report parameters for both of these examples are as follows: The period of interest start date is 1/1/12, the period of interest end date is 12/31/12, the period of interest was closed (closing date) on 3/16/13, and the prior period ended on 12/31/11 and was closed (prior period closing date) on 4/19/12. The transactions in this example were selected because they are examples of the date scenarios described in Table 1.

### Example 1

The transactions entered utilizing the current conventional methodology found in most accounting systems. Please note that the term “Reference Date” is included here to indicate where the relevant period is for each part of the transaction.

Transaction 1:

| | | Transaction | Reference | | | |
|---|---|---|---|---|---|---|
| Line | Type | Date | Date | Account | Debit | Credit |
| 1 | Bill | Sep. 10, 2011 | | Accounts | | 250 |
| | | | | Payable | | |
| 2 | | Sep. 10, 2011 | Aug. 12, 2011 | Wholesale | 250 | |
| | | | | Office | | |
| | | | | Supplies | | |

No General Journal Entries required

Transaction 2:

| | | Transaction | Ref | | | |
|---|---|---|---|---|---|---|
| Line | Type | Date | Date | Account | Debit | Credit |
| 3 | Bill | Feb. 10, 2012 | | Accounts | | 450 |
| | | | | Payable | | |
| 4 | | Feb. 10, 2012 | Nov. 30, 2011 | Electric | 450 | |
| | | | | Utility | | |

General Journal Entries related to Transaction 2

| | | Transaction | | | |
|---|---|---|---|---|---|
| Line | Type | Date | Account | Debit | Credit |
| 3a | Journal | Nov. 30, 2011 | Retained Earnings | | 450 |
| 4a | | Nov. 30, 2011 | Electric Utility | 450 | |
| 3b | Journal | Feb. 10, 2012 | Retained Earnings | 450 | |
| 4b | | Feb. 10, 2012 | Electric Utility | | 450 |

Transaction 3:

| Line | Type | Transaction Date | Reference Date | Account | Debit | Credit |
|---|---|---|---|---|---|---|
| 5 | Check | Apr. 21, 2012 | | EveryWhere | | 340 |
| | | | | BankCorp-Checking | | |
| 6 | | Apr. 21, 2012 | Oct. 31, 2011 | Phone Expenses | 170 | |
| 7 | | Apr. 21, 2012 | Nov. 30, 2011 | Phone Expenses | 170 | |

General Journal Entries related to Transaction 3

| Line | Type | Transaction Date | Account | Debit | Credit |
|---|---|---|---|---|---|
| 5a | Journal | Oct. 31, 2011 | Prior Period Adjustments | | 170 |
| 6a | | Oct. 31, 2011 | Phone Expenses | 170 | |
| 5b | Journal | Apr. 21, 2012 | Prior Period Adjustments | 170 | |
| 6b | | Apr. 21, 2012 | Phone Expenses | | 170 |
| 5c | Journal | Nov. 30, 2011 | Prior Period Adjustments | | 170 |
| 7a | | Nov. 30, 2011 | Phone Expenses | 170 | |
| 5d | Journal | Apr. 21, 2012 | Prior Period Adjustments | 170 | |
| 7b | | Apr. 21, 2012 | Phone Expenses | | 170 |

Transaction 4:

| Line | Type | Transaction Date | Reference Date | Account | Debit | Credit |
|---|---|---|---|---|---|---|
| 8 | Bill | Jan. 15, 2013 | | Accounts Payable | | 120 |
| 9 | | Jan. 15, 2013 | Dec. 31, 2011 | Internet Service | 120 | |

General Journal Entries related to Transaction 4

| Line | Type | Transaction Date | Account | Debit | Credit |
|---|---|---|---|---|---|
| 8a | Journal | Dec. 31, 2012 | Prior Period Adjustment | 120 | |
| 9a | | Dec. 31, 2012 | Other Payables | | 120 |
| 8b | Journal | Jan. 15, 2013 | Accounts Payable | 120 | |
| 9b | | Jan. 15, 2013 | Internet Service | | 120 |
| 8c | | Jan. 15, 2013 | Prior Period Adjustment | | 120 |
| 9c | | Jan. 15, 2013 | Other Payables | 120 | |

Transaction 5:

| Line | Type | Transaction Date | Reference Date | Account | Debit | Credit |
|---|---|---|---|---|---|---|
| 10 | Check | Dec. 31, 2011 | | EveryWhere | | 1250 |
| | | | | BankCorp-Checking | | |
| 11 | | Dec. 31, 2011 | Jan. 31, 2012 | Health Insurance | 1250 | |

General Journal Entries related to Transaction 5

| Line | Type | Transaction Date | Account | Debit | Credit |
|---|---|---|---|---|---|
| 10a | Journal | Jan. 31, 2012 | Subsequent Period Adjustments | | 1250 |
| 11a | | Jan. 31, 2012 | Health Insurance | 1250 | |
| 10b | Journal | Dec. 31, 2011 | Subsequent Period Adjustments | 1250 | |
| 11b | | Dec. 31, 2011 | Health Insurance | | 1250 |

Transaction 6:

| | | Transaction | Reference | | | |
|---|---|---|---|---|---|---|
| Line | Type | Date | Date | Account | Debit | Credit |
| 12 | Bill | Mar. 16, 2012 | | Accounts | | 600 |
| | | | | Payable | | |
| 13 | | Mar. 16, 2012 | Feb. 28, 2012 | Auto | 600 | |
| | | | | Insurance | | |

Transaction 7:

| | | Transaction | Reference | | | |
|---|---|---|---|---|---|---|
| Line | Type | Date | Date | Account | Debit | Credit |
| 14 | Invoice | May 13, 2012 | | Regular | | 8700 |
| | | | | Receivable | | |
| 15 | | May 13, 2012 | Apr. 30, 2012 | Computer | 8700 | |
| | | | | Parts Sold | | |

No general journal entries required

Transaction 8

| Line | Type | Transaction Date | Reference Date | Account | Debit | Credit |
|---|---|---|---|---|---|---|
| 16 | Check | Jan. 15, 2013 | | EveryWhere | | 175 |
| | | | | BankCorp-Checking | | |
| 17 | | Jan. 15, 2013 | Dec. 31, 2012 | Gas Utility | 175 | |

General Journal Entries related to Transaction 8

| Line | Type | Transaction Date | Account | Debit | Credit |
|---|---|---|---|---|---|
| 16a | Journal | Dec. 31, 2012 | Other Payables | | 175 |
| 17a | | Dec. 31, 2012 | Gas Utility | 175 | |
| 16b | Journal | Jan. 15, 2013 | Other Payables | 175 | |
| 17b | | Jan. 15, 2013 | Gas Utility | | 175 |

Transaction 9:

| Line | Type | Transaction Date | Reference Date | Account | Debit | Credit |
|---|---|---|---|---|---|---|
| 18 | Check | Dec. 31, 2011 | | EveryWhere | | 500 |
| | | | | BankCorp-Checking | | |
| 19 | | Dec. 31, 2011 | Jan. 1, 2013 | Workers Comp | 500 | |
| | | | | Insurance Expense | | |

General Journal Entries related to Transaction 9

| Line | Type | Transaction Date | Account | Debit | Credit |
|---|---|---|---|---|---|
| 18a | Journal | Dec. 31, 2011 | Subsequent Period Adjustment | 500 | |
| 19a | | Dec. 31, 2011 | Workers Comp Insurance Expense | | 500 |
| 18b | Journal | Jan. 1, 2013 | Workers Comp Insurance Expense | 500 | |
| 19b | | Jan. 1, 2013 | Subsequent Period Adjustment | | 500 |

Transaction 10:

| Line | Type | Transaction Date | Reference Date | Account | Debit | Credit |
|---|---|---|---|---|---|---|
| 20 | Check | Dec. 31, 2012 | | EveryWhere | | 900 |
| | | | | BankCorp-Checking | | |
| 21 | | Dec. 31, 2012 | Jan. 1, 2013 | Advertising | 900 | |

General Journal Entries related to Transaction 10

| Line | Type | Transaction Date | Account | Debit | Credit |
|---|---|---|---|---|---|
| 20a | Journal | Jan. 1, 2013 | Subsequent Period Adjustments | | 900 |
| 21a | | Jan. 1, 2013 | Advertising | 900 | |
| 20b | Journal | Dec. 31, 2012 | Subsequent Period Adjustments | 900 | |
| 21b | | Dec. 31, 2012 | Advertising | | 900 |

Transaction 11:

| Line | Type | Transaction Date | Reference Date | Account | Debit | Credit |
|---|---|---|---|---|---|---|
| 22 | Deposit | Dec. 31, 2012 | | EveryWhere | | 1500 |
| | | | | BankCorp-Checking | | |
| 23 | | Dec. 31, 2012 | Jan. 1, 2013 | Dental Services Provided | 1500 | |

General Journal Entries related to Transaction 11

| Line | Type | Transaction Date | Account | Debit | Credit |
|---|---|---|---|---|---|
| 22a | Journal | Jan. 1, 2013 | Subsequent Period Adjustments | 1500 | |
| 23a | | Jan. 1, 2013 | Dental Services Provided | | 1500 |
| 22b | Journal | Dec. 31, 2012 | Subsequent Period Adjustments | | 1500 |
| 23b | | Dec. 31, 2012 | Dental Services Provided | 1500 | |

A transaction involving the purchase of an asset and the subsequent depreciation of that asset.

Transaction 12:

| | | Transaction | | | |
|---|---|---|---|---|---|
| Line | Type | Date | Account | Debit | Credit |
| 24 | Check | Jun. 4, 2012 | EveryWhere BankCorp- | | 2800 |
| | | | Checking | | |
| 25 | | Jun. 4, 2012 | Phone System (Asset Account) | 2800 | |

General Journal Entries related to Transaction 12

| | | | | | |
|---|---|---|---|---|---|
| 26a | Journal | Jan. 1, 2012 | Accumulated Depreciation | | 560 |
| 27a | | Jan. 1, 2012 | Depreciation Expense | 560 | |
| 26b | Journal | Jan. 1, 2013 | Accumulated Depreciation | | 560 |
| 28a | | Jan. 1, 2013 | Depreciation Expense | 560 | |
| 26c | Journal | Jan. 1, 2014 | Accumulated Depreciation | | 560 |
| 29a | | Jan. 1, 2014 | Depreciation Expense | 560 | |
| 26d | Journal | Jan. 1, 2015 | Accumulated Depreciation | | 560 |
| 30a | | Jan. 1, 2015 | Depreciation Expense | 560 | |
| 26e | Journal | Jan. 1, 2016 | Accumulated Depreciation | | 560 |
| 31a | | Jan. 1, 2016 | Depreciation Expense | 560 | |

In light of the foregoing entries, the following shows an income statement created in accordance with convention methodologies. The line reference refers to the parts of the transactions listed in the foregoing entries.

Income Statement according to a conventional method.

| | | Line |
|---|---|---|
| | | Reference |
| Account Description | Total | |
| Income | | |
| Computer Parts Sold | 8700 | 15 |
| Dental Services Provided | 0 | 23, 23b |
| Total Income | 8700 | |
| Gross Profit | 8700 | |
| Expense | | |
| Electric utility | 0 | 4, 4b |
| Phone Expenses | 0 | 6, 7, 6b, 7b |
| Internet Service | 0 | |
| Auto Insurance | 600 | 13 |
| Gas Utility | 175 | 17a |
| Advertising | 0 | 21, 21b |
| Depreciation Expense | 560 | 27a |
| Health Insurance | 1250 | 11a |
| Total Expense | 2585 | |
| Net Income | 6115 | |
| Retained Earnings Worksheet- | | |
| Conventional Method (Date Before | | Line |
| Period) | | Reference |
| Account Description | | |
| Income | 0 | |
| Expense | | |
| Health Insurance | 0 | 11, 11b |
| Workers Comp Insurance | 0 | 19, 19a |
| Expense | | |
| Office Supplies | −250 | 2 |
| Electric utility | −450 | 4a |
| Retained Earnings | −700 | |

Additionally, a balance sheet corresponding to the foregoing entries is created in accordance with conventional methodologies.

| Balance Sheet - Conventional | | Line Reference |
|---|---|---|
| Account Description | Total | |
| Bank Accounts | | |
| EveryWhere BankCorp-Checking | −4290 | 22, 5, 10, 18, 20, 24 |
| Total Bank Accounts | −4290 | |
| Fixed Assets | | |
| Phone System | 2800 | 25 |
| Phone System-Acc Depreciation | −560 | 26a |
| Total Fixed Assets | 2240 | |
| Accounts Receivable | | |
| Regular Receivable | 8700 | 14 |
| Total Accounts Receivable | 8700 | |
| Other Current Asset | 0 | |
| Total Other Current Asset | 0 | |
| Total Assets | 6650 | |
| Accounts Payable | | |
| Accounts Payable | 1300 | 1, 3, 12 |
| Other Payables | 295 | 9a, 16a |
| Total Accounts Payable | 1595 | |
| Other Current Liability | 1595 | |
| Total Other Current Liability | 1595 | |
| Total Liabilities | 1595 | |
| Equity | | |
| Prior Period Adjustment | −460 | 6a, 7a, 8a |
| Retained Earnings | −700 | 2, 4a, 11, 11b, 19, 19a |
| Total Equity | −1160 | |
| Net Income | 6115 | See Income |
| | | Statement |
| Subsequent Period | 100 | 10a, 10b, 18a, 20b, 22b |
| Adjustments | | |
| Total Owners Equity and | 6650 | |
| Liability | | |

The example below illustrates how the dual-date accounting methodology of some embodiments of the present invention can be utilized to create these two reports using similar transactions with an Accrual Date. Using the described dual-date accounting methodologies, an accountant may wish to use other accounts other than those in examples used below. In this regard, the specific accounts used in the following example are not necessarily important, but are simply used to illustrate how the dual-date accounting methodology can be used to generate a financial report without the use of journal entries. While such journal entries are not necessary for some embodiments of the dual-date methods, individuals and businesses may still choose to use some journal entries (e.g., in the transfer of amounts from one balance sheet account to another).

A transaction having an [Accrual Date] before the period of interest and a [Transaction Date] within the period of interest but before the prior period closing date is shown below:

Transaction 1:

| | | Transaction | Accrual | | | |
|---|---|---|---|---|---|---|
| Line | Type | Date | Date | Account | Debit | Credit |
| 1 | Bill | Sep. 10, 2011 | | Accounts | | 250 |
| | | | | Payable | | |
| 2 | | Sep. 10, 2011 | Aug. 12, 2011 | Wholesale | 250 | |
| | | | | Office | | |
| | | | | Supplies | | |

No General Journal Entries required

A transaction having an [Accrual Date] before the period of interest and a [Transaction Date] within the period of interest but before the prior period closing date is shown below:

Transaction 2:

| | | Transaction | Accrual | | | |
|---|---|---|---|---|---|---|
| Line | Type | Date | Date | Account | Debit | Credit |
| 3 | Bill | Feb. 10, 2012 | | Accounts | | 450 |
| | | | | Payable | | |
| 4 | | Feb. 10, 2012 | Nov. 30, 2011 | Electric | 450 | |
| | | | | Utility | | |

No General Journal Entries required

A transaction having an [Accrual Date] before the period of interest and a [Transaction Date] within the period of interest but after the prior period closing date is shown below:

Transaction 3:

| | | Transaction | Accrual | | | |
|---|---|---|---|---|---|---|
| Line | Type | Date | Date | Account | Debit | Credit |
| 5 | Check | Apr. 21, 2012 | | EveryWhere | | 340 |
| | | | | BankCorp- | | |
| | | | | Checking | | |
| 6 | | Apr. 21, 2012 | Oct. 31, 2011 | Phone | 170 | |
| | | | | Expenses | | |
| 7 | | Apr. 21, 2012 | Nov. 30, 2011 | Phone | 170 | |
| | | | | Expenses | | |

No General Journal Entries required

A transaction having an [Accrual Date] before the period of interest and a [Transaction Date] after the period of interest is shown below:

Transaction 4:

| | | Transaction | Accrual | | | |
|---|---|---|---|---|---|---|
| Line | Type | Date | Date | Account | Debit | Credit |
| 8 | Bill | Jan. 15, 2013 | | Accounts | | 120 |
| | | | | Payable | | |
| 9 | | Jan. 15, 2013 | Dec. 31, 2011 | Internet Service | 120 | |

A transaction having an [Accrual Date] within the period of interest and a [Transaction Date] before the period of interest is shown below:

Transaction 5:

| | | Transaction | Accrual | | | |
|---|---|---|---|---|---|---|
| Line | Type | Date | Date | Account | Debit | Credit |
| 10 | Check | Dec. 31, 2011 | | EveryWhere | | 1250 |
| | | | | BankCorp- | | |
| | | | | Checking | | |
| 11 | | Dec. 31, 2011 | Jan. 31, 2012 | Health | 1250 | |
| | | | | Insurance | | |

No General Journal Entries required

Some transactions having an [Accrual Date] within the period of interest and a [Transaction Date] within the period of interest are shown below:

Transaction 6:

| | | Transaction | Accrual | | | |
|---|---|---|---|---|---|---|
| Line | Type | Date | Date | Account | Debit | Credit |
| 12 | Bill | Mar. 16, 2012 | | Accounts | | 600 |
| | | | | Payable | | |
| 13 | | Mar. 16, 2012 | Feb. 28, 2012 | Auto | 600 | |
| | | | | Insurance | | |

No General Journal Entries required

Transaction 7:

| | | Transaction | Accrual | | | |
|---|---|---|---|---|---|---|
| Line | Type | Date | Date | Account | Debit | Credit |
| 14 | Invoice | May 13, 2012 | | Regular | | 8700 |
| | | | | Receivable | | |
| 15 | | May 13, 2012 | Apr. 30, 2012 | Computer | 8700 | |
| | | | | Parts Sold | | |

No General Journal Entries required

A transaction having an [Accrual Date] within the period of interest and a [Transaction Date] after the period of interest is shown below:

Transaction 8

| | | Transaction | Accrual | | | |
|---|---|---|---|---|---|---|
| Line | Type | Date | Date | Account | Debit | Credit |
| 16 | Check | Jan. 15, 2013 | | EveryWhere | | 175 |
| | | | | BankCorp- | | |
| | | | | Checking | | |
| 17 | | Jan. 15, 2013 | Dec. 31, 2012 | Gas Utility | 175 | |

A transaction having an [Accrual Date] after the period of interest and a [Transaction Date] before the period of interest is shown below:

Transaction 9:

| | | Transaction | Accrual | | | |
|---|---|---|---|---|---|---|
| Line | Type | Date | Date | Account | Debit | Credit |
| 18 | Check | Dec. 31, 2011 | | EveryWhere | | 500 |
| | | | | BankCorp- | | |
| | | | | Checking | | |
| 19 | | Dec. 31, 2011 | Jan. 1, 2013 | Workers Comp | 500 | |
| | | | | Insurance | | |
| | | | | Expense | | |

Some transactions having an [Accrual Date] after the period of interest and a [Transaction Date] within the period of interest are shown below:

Transaction 10:

| | | Transaction | Accrual | | | |
|---|---|---|---|---|---|---|
| Line | Type | Date | Date | Account | Debit | Credit |
| 20 | Check | Dec. 31, 2012 | | EveryWhere | | 900 |
| | | | | BankCorp- | | |
| | | | | Checking | | |
| 21 | | Dec. 31, 2012 | Jan. 1, 2013 | Advertising | 900 | |

Transaction 11:

| | | Transaction | Accrual | | | |
|---|---|---|---|---|---|---|
| Line | Type | Date | Date | Account | Debit | Credit |
| 22 | Deposit | Dec. 31, 2012 | | EveryWhere | | 1500 |
| | | | | BankCorp- | | |
| | | | | Checking | | |
| 23 | | Dec. 31, 2012 | Jan. 1, 2013 | Dental | 1500 | |
| | | | | Services | | |
| | | | | Provided | | |

A transaction involving the purchase of an asset and the subsequent depreciation of that asset.

Transaction 12:

| | | Transaction | Accrual | | | |
|---|---|---|---|---|---|---|
| Line | Type | Date | Date | Account | Debit | Credit |
| 24 | Check | Jun 4, 2012 | | EveryWhere | | 2800 |
| | | | | BankCorp- | | |
| | | | | Checking | | |
| 25 | | Jun 4, 2012 | | Phone System | 2800 | |
| | | | | (Asset Account) | | |
| 26 | | Jun 4, 2012 | | Phone System - | | 2800 |
| | | | | Accumulated | | |
| | | | | Depreciation | | |
| 27 | | Jun 4, 2012 | Dec. 31, 2012 | Depreciation | 560 | |
| | | | | Expense | | |
| 28 | | Jun 4, 2012 | Dec. 31, 2013 | Depreciation | 560 | |
| | | | | Expense | | |
| 29 | | Jun 4, 2012 | Dec. 31, 2014 | Depreciation | 560 | |
| | | | | Expense | | |
| 30 | | Jun 4, 2012 | Dec. 31, 2015 | Depreciation | 560 | |
| | | | | Expense | | |
| 31 | | Jun 4, 2012 | Dec. 31, 2016 | Depreciation | 560 | |
| | | | | Expense | | |

No General Journal Entries required

In light of the foregoing entries, the following shows an income statement created in accordance with some embodiments of the described dual-date account methodology. The line reference refers to the parts of the transactions listed in the foregoing entries.

The following shows an income statement created in accordance with an embodiment of the invention:

| | | Line |
|---|---|---|
| Income Statement - New Method | | Reference |
| Account Description | Total | |
| Income | | |
| Computer Parts Sold | 8700 | 15 |
| Total Income | 8700 | |
| Gross Profit | 8700 | |
| Expense | | |
| Health Insurance | 1250 | 11 |
| Auto Insurance | 600 | 13 |
| Gas Utility | 175 | 17 |
| Depreciation Expense | 560 | 27 |
| Total Expense | 2585 | |
| Net Income | 6115 | |
| Retained Earnings Worksheet- New | | Line |
| Method | | Reference |
| Account Description | | |
| Income | 0 | |
| Expense | | |
| Office Supplies | −250 | 2 |
| Electric Utility | −450 | 4 |
| Retained Earninis | −700 | |

Additionally, a balance sheet corresponding to the foregoing entries is created in accordance with a representative embodiment of the present invention.

| Balance Sheet - New Method | | Line reference |
|---|---|---|
| Account Description | Total | |
| Bank Accounts | | |
| EveryWhere BankCorp-Checking | −4290 | 22, 5, 10, 18, 20, 24 |
| Total Bank Accounts | −4290 | |
| Fixed Assets | | |
| Phone System | 2800 | 25 |
| Phone System-Acc Depreciation | −560 | 26, 28, 29, 30, 31 |
| Total Fixed Assets | 2240 | |
| Accounts Receivable | | |
| Regular Receivable | 8700 | 14 |
| Total Accounts Receivable | 8700 | |
| Other Current Asset | 0 | |
| Total Other Current Asset | 0 | |
| Total Assets | 6650 | |
| Accounts Payable | | |
| Accounts Payable | 1300 | 1, 3, 12 |
| Other Payables | 295 | 9, 17 |
| Total Accounts Payable | 1595 | |
| Other Current Liability | 1595 | |
| Total Other Current Liability | 1595 | |
| Total Liabilities | 1595 | |
| Equity | | |
| Prior Period Adjustment | −460 | |
| Retained Earnings | −700 | 6, 7, 9 |
| Total Equity | −1160 | 2, 4 |
| Net Income | 6115 | |
| Subsequent Period | 100 | See Income |
| Adjustments | | Statement |
| Total Owners Equity and | 6650 | 19, 21, 23 |
| Liability | | |

In some implementations, utilization of the described dual-date accounting methodology allows the system (e.g., a computer and/or software running the methodology) to lock transactions. In this regard, the term lock may be used herein to refer to the disallowance of the user to modify or delete key parts of a transaction. Those key parts can be, but are not limited to, the Accrual Date, the Transaction Date, the Debit amount, the Credit amount, or the account. This could be done according to one or more of the following methodologies. Indeed, in some embodiments, after closing a period, a transaction is deemed locked or not editable under the following conditions: The [Transaction Date] is within a closed period. The transaction may be in an open period yet have components which are linked to income statement accounts which have an [Accrual Date] which is within a closed period and that closed period has a closing date that is after the [Transaction Date]. In some embodiments of this system, only individual parts of the transaction that meet the criteria listed above are locked. Additionally, in some embodiments, creating a new transaction or altering an existing transaction that will create a transaction that meets the aforementioned criteria is also not permitted.

All scenarios described and any other method for locking or rendering un-editable transactions (or parts of transactions) are included within the scope of the invention.

In accordance with some embodiments, when modifying or voiding closed transactions, the described systems and methods do not alter or delete the debit, credit, account, transaction date, and/or accrual date information within the original transaction, but instead create one or more reversing entries for all of the debit and credit amounts into a new transaction and assigns a [Transaction Date] equal to the current date (which is presumably not in a closed period). This may also be accomplished in any suitable manner, including, without limitation, by marking the original transaction parts, annotating the date of reversal, and then having the system create a reversing query that is stored as a transaction using the date of reversal as the [Transaction Date] within the query. In some embodiments, if the transaction is not voided, but is instead being modified, the system also creates another copy of the original transaction, leaving the original debit and credit amounts intact and assigns the transaction a [Transaction Date] equal to the current date (which is presumably not in a closed period). To facilitate ease of use for the user, these new transactions can be related to the original transaction using any suitable type of methodology, such as a reference ID that links the reversing transaction to the original transaction's transaction ID.

### EXAMPLES

To provide a better understanding of the described systems and methods, several representative examples illustrating conventional methodologies and contrasting examples showing application of some embodiments of the described dual-date methodologies are provided below.

### Example I

The following is an example of a transaction entered into a system prior to the closing of the period. In this example, a company receives a bill from “On the Go Wireless” on February 10, 2012 for the previous three months of mobile phone expenses. In this regard, the company was unaware until the receipt of said bill that it owed this money. As a follow up to the bill, the company issued a check on the same day it received the bill. Additionally, the 2011 financial period for the company will be closed on 4/19/12.

The following represents how that transaction would be entered utilizing a current accounting practice. In this regard, it should be noted that these entries could also be done with bills instead of journal entries and a bill payment check instead of a check.

Transaction in Accordance with a Conventional Technique

| | | Transaction | | | |
|---|---|---|---|---|---|
| Line | Type | Date | Account | Debit | Credit |
| 1 | Check | Feb. 10, 2012 | EveryWhere BankCorp- | | 375 |
| | | | Checking | | |
| 2 | | Feb. 10, 2012 | Other Payables | 375 | |
| 3 | Journal | Nov. 30, 2011 | Other Payables | | 150 |
| 4 | | Nov. 30, 2011 | Phone Expenses | 150 | |
| 5 | Journal | Dec. 31, 2011 | Other Payables | | 125 |
| 6 | | Dec. 31, 2011 | Phone Expenses | 125 | |
| 7 | Journal | Jan. 31, 2012 | Other Payables | | 100 |
| 8 | | Jan. 31, 2012 | Phone Expenses | 100 | |

In contrast with the foregoing conventional technique, at least one representative embodiment of the present invention would record the entries as a single transaction. Thus, the following provides an example of how the transaction looks, wherein the [Accrual Date] is the date to which the each of the individual expenses belongs, and wherein the [Transaction Date] is the date on which the bill is paid.

Transaction in Accordance with Some Embodiments of the
Current Invention

| | | Transaction | Accrual | | | |
|---|---|---|---|---|---|---|
| Line | Type | Date | Date | Account | Debit | Credit |
| 9 | Check | Feb. 10, 2012 | | EveryWhere | | 375 |
| | | | | BankCorp- | | |
| | | | | Checking | | |
| 10 | | Feb. 10, 2012 | Nov. 30, 2011 | Phone | 150 | |
| | | | | Expenses | | |
| 11 | | Feb. 10, 2012 | Dec. 31, 2011 | Phone | 125 | |
| | | | | Expenses | | |
| 12 | | Feb. 10, 2012 | Jan. 31, 2012 | Phone | 100 | |
| | | | | Expenses | | |

### Example II

The following is an example of a transaction entered into the system after a period has closed. In this example, a company finds a bill from “On the Go Wireless” on Apr. 21, 2012 (two days after closing the previous year), dated Feb. 10, 2012, which was for the previous three months of mobile phone expenses. In this example, the company was unaware until then (Apr. 21, 2012) that it owed this money. Nevertheless, it issued a check to “On the Go Wireless” on Apr. 21, 2012. The 2011 financial period for the company was closed on 4/19/2012.

The following represents how that transaction would be entered utilizing a current accounting practice. In particular, this conventional method requires the knowledge of when the previous period was closed. If that closing date were to change to a later date (4/30/12, for example) then all of the transactions related to the prior period would have to be reviewed and potentially modified. Additionally, under this conventional technique, the prior period adjustment does not indicate which prior period to which the expense belongs.

Transaction in Accordance with a Conventional Technique

| | | Transaction | | | |
|---|---|---|---|---|---|
| Line | Type | Date | Account | Debit | Credit |
| 1 | Check | Apr. 21, 2012 | EveryWhere BankCorp- | | 375 |
| | | | Checking | | |
| 2 | | Apr. 21, 2012 | Prior period Adjustment | 275 | |
| 3 | | Apr. 21, 2012 | Other Payables | 100 | |
| 4 | Journal | Jan. 31, 2012 | Other Payables | | 100 |
| 5 | | Jan. 31, 2012 | Phone Expenses | 100 | |

In contrast (and as shown below), a representative embodiment of the present invention would record the entries as a single transaction. Thus, the following shows how that transaction looks using a representative embodiment of the present invention. Note that the entry remains unchanged regardless of closing scenarios.

Transaction in Accordance with Some Embodiments of the
Current Invention

| | | Transaction | Accrual | | | |
|---|---|---|---|---|---|---|
| Line | Type | Date | Date | Account | Debit | Credit |
| 6 | Check | Apr. 21, 2012 | | EveryWhere | | 375 |
| | | | | BankCorp- | | |
| | | | | Checking | | |
| 7 | | Apr. 21, 2012 | Nov. 30, 2011 | Phone | 150 | |
| | | | | Expenses | | |
| 8 | | Apr. 21, 2012 | Dec. 31, 2011 | Phone | 125 | |
| | | | | Expenses | | |
| 9 | | Apr. 21, 2012 | Jan. 31, 2012 | Phone | 100 | |
| | | | | Expenses | | |

### Example III

The following is an example of voiding a closed transaction from a closed period. As part of this example, on Aug. 21, 2012 (after the prior period has closed), the company gets a check back un-cashed. In response, the company calls the vendor who states that the original bill (e.g., for $375) was sent out in error and that the company did not owe the money after all.

The following represents how such a transaction would be entered utilizing a conventional accounting practice. Due to the fact that the original check has a [Transaction Date] within a closed period, the original transaction cannot be modified. Accordingly, knowledge of when the period to which the [Transaction Date] belongs was closed is required. Additionally, a general journal entry is typically required to enter the appropriate amounts in the appropriate accounts.

Transaction in Accordance with a Conventional Technique

| | | Transaction | | | |
|---|---|---|---|---|---|
| Line | Type | Date | Account | Debit | Credit |
| 1 | Journal | Aug. 21, 2012 | EveryWhere BankCorp- | 375 | |
| | | | Checking | | |
| 2 | | Aug. 21, 2012 | Phone Expenses | | 100 |
| 3 | | Aug. 21, 2012 | Prior Period Adjustments | | 275 |

In contrast, some embodiments of the present invention do not require knowledge of closing dates to complete such a transaction. Moreover, in some such embodiments, the original entry can be left untouched. Instead, a reversing entry (an example of which is shown below) is linked (e.g., in any suitable manner) to the original transaction. In this regard and in at least some embodiments, the reversing entry is the same as the original transaction in terms of accounts and amounts, with the exception that the [Transaction Date] is the current date (date of awareness 8/1/12), the credit amounts of the new transaction equal the debit amounts of the original transaction, and the debit amounts of the new transaction equal the credit amounts of the original transaction.

Transaction in Accordance with Some Embodiments of the
Current Invention

| | | Transaction | Accrual | | | |
|---|---|---|---|---|---|---|
| Line | Type | Date | Date | Account | Debit | Credit |
| 4 | Void | Aug. 21, 2012 | | EveryWhere | 375 | |
| | | | | BankCorp- | | |
| | | | | Checking | | |
| 5 | | Aug. 21, 2012 | Nov. 30, 2011 | Phone | | 150 |
| | | | | Expenses | | |
| 6 | | Aug. 21, 2012 | Dec. 31, 2011 | Phone | | 125 |
| | | | | Expenses | | |
| 7 | | Aug. 21, 2012 | Jan. 31, 2012 | Phone | | 100 |
| | | | | Expenses | | |

### Example IV

The following is an example of modifying a transaction from a closed period. On Aug. 21, 2012 (after the prior period has closed), the company in this example gets a check back un-cashed. As a result, the company calls the vendor, who states that the original bill was incorrect. The amount the company owed for January 2012 was actually $90 instead of $100, and the amount owed for December 2011 was actually $130 instead of $125.

The following represents how that transaction would be entered utilizing a current accounting practice. In particular, due to the fact that the original check has a [Transaction Date] prior to the period of interest closing date, the original transaction in this example cannot be modified. Moreover, knowledge of when the period of interest closing date occurred is also required. Furthermore, the changes desired must be reflected in a new transaction, generally a “journal entry”, with all income and expense changes entered as prior period adjustment.

The original Transaction in Accordance with a Conventional
Technique

| | | Transaction | | | |
|---|---|---|---|---|---|
| Line | Type | Date | Account | Debit | Credit |
| 1 | Check | Apr. 21, 2012 | EveryWhere BankCorp- | | 375 |
| | | | Checking | | |
| 2 | | Apr. 21, 2012 | Prior period Adjustment | 275 | |
| 3 | | Apr. 21, 2012 | Other Payables | 100 | |

New Transaction in Accordance with a Conventional Technique

| | | Transaction | | | |
|---|---|---|---|---|---|
| Line | Type | Date | Account | Debit | Credit |
| 1 | Journal | Aug. 21, 2012 | EveryWhere BankCorp- | 5 | |
| | | | Checking | | |
| 2 | | Aug. 21, 2012 | Phone Expenses | | 10 |
| 2 | | Aug. 21, 2012 | Prior Period Adjustment | 5 | |

In contrast, some embodiments of the present invention would not require knowledge of closing dates to complete the transaction in this example. Moreover, in some such embodiments, the original entry is untouched. Instead, a reversing entry (an example of which is shown below) is linked is some manner to the original transaction. In this regard, the system creates a reversing entry that is similar to the one used for voiding (see Example III above). In some embodiments, the system then also creates another new entry that matches the original transaction, but with the current date (08/21/12 instead of the old date 2/10/12) as the [Transaction Date]. The new transaction can then be modified as necessary.

The original Transaction in Accordance with Some Embodiments of the
Current Invention

| | | Transaction | Accrual | | | |
|---|---|---|---|---|---|---|
| Line | Type | Date | Date | Account | Debit | Credit |
| 6 | Check | Apr. 21, 2012 | | EveryWhere | | 375 |
| | | | | BankCorp- | | |
| | | | | Checking | | |
| 7 | | Apr. 21, 2012 | Nov. 30, 2011 | Phone | 150 | |
| | | | | Expenses | | |
| 8 | | Apr. 21, 2012 | Dec. 31, 2011 | Phone | 125 | |
| | | | | Expenses | | |
| 9 | | Apr. 21, 2012 | Jan. 31, 2012 | Phone | 100 | |
| | | | | Expenses | | |

Transaction in Accordance with Some Embodiments of the
Current Invention

| | | Transaction | Accrual | | | |
|---|---|---|---|---|---|---|
| Line | Type | Date | Date | Account | Debit | Credit |
| 4 | Void | Aug. 21, 2012 | | EveryWhere | 375 | |
| | | | | BankCorp- | | |
| | | | | Checking | | |
| 5 | | Aug. 21, 2012 | Nov. 30, 2011 | Phone | | 150 |
| | | | | Expenses | | |
| 6 | | Aug. 21, 2012 | Dec. 31, 2011 | Phone | | 125 |
| | | | | Expenses | | |
| 7 | | Aug. 21, 2012 | Jan. 31, 2012 | Phone | | 100 |
| | | | | Expenses | | |
| 4 | Check | Aug. 21, 2012 | | EveryWhere | | 370 |
| | | | | BankCorp- | | |
| | | | | Checking | | |
| 5 | | Aug. 21, 2012 | Nov. 30, 2011 | Phone | 150 | |
| | | | | Expenses | | |
| 6 | | Aug. 21, 2012 | Dec. 31, 2011 | Phone | 130 | |
| | | | | Expenses | | |
| 7 | | Aug. 21, 2012 | Jan. 31, 2012 | Phone | 90 | |
| | | | | Expenses | | |

### Operating Environments

As mentioned above, one skilled in the art will appreciate that embodiments of the present invention may be practiced by one or more computing devices and in a variety of system configurations, including in a networked configuration. Accordingly, FIG. 1 and the corresponding discussion provide a general description of a suitable operating environment in which embodiments of the invention may be implemented. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), standalone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a touch screen, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, web-based environments, cloud-based computing (e.g., software as a service), and/or wide area networked environments, such as the Internet.

Embodiments of the invention utilize computer environments and systems such as those described above to provide powerful accounting advantages using a dual-date accounting methodology. The dual-date accounting methodology utilizes a [Transaction Date] which is consistent for all parts of the transaction. In addition to said [Transaction Date], in some embodiments, this invention stipulates that all parts of a transaction that are related to any form of income or expense account are required to also have an [Accrual Date]. This date, unlike the [Transaction Date], may be different for each part within the transaction. A properly-programmed computer system utilizes the dates of each entry or part within each transaction along with a register of dates defining accounting periods (e.g., opening and closing dates for each period, or the like) to provide various accounting reports while eliminating the need to prepare and enter most to all general journal entries. In some cases, most, if not all, reports are rapidly and accurately accumulated and are automatically accrued to the correct period. Accordingly, in some embodiments, timely and accurate financials are available at virtually any time, without the need for manually produced adjusting entries given all currently-recorded transactions. Additionally, in some embodiments, the described system is also highly auditable as all financial information is based on exact entries and minimal to no research time is necessary to address audit needs. Simple rules need only be in place to ensure that the [Transaction Date] and the [Accrual Date] are accurately and consistently entered. If desired, a regulatory body could determine or mandate how the [Transaction Date] and the [Accrual Date] are to be recorded. Recording procedures for transactions could follow the same date guidelines regardless of when the referenced accounting period has closed.

The foregoing examples should be understood as being exemplary of how embodiments of the invention provide many advantages in accounting and preparing reports and minimize the need for general journal entries to properly relate transactions that occurred in one period but are for work, goods, or services from another period to the correct period to which they relate. Further, the provided examples should be understood as particular methods of deriving the stated calculations only and are not the only possible methods for deriving such calculations. For example, similar calculations may be obtained using a computer process that summarizes transactions of the balance sheet account using the [Accrual Date] instead of the [Transaction Date] and completing a different set of adjustments. The calculations and system described above are simply the best mode currently known to practically meet desired objectives with the most streamlined access to underlying data.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A processing apparatus comprising:
a processor;
computer-readable media that is accessible by the processor;
a first entry having a first reference identification, the first entry being stored in a locked state on the computer-readable media; and
a second entry having a second reference identification that is linked to the first reference identification.

2. A processing apparatus as recited in claim 1, wherein the computer-readable media comprises a first computer-readable medium and a second computer-readable medium, and wherein the first entry is stored in a locked state on the first computer-readable medium.

3. A processing apparatus as recited in claim 2, wherein the second entry is stored on the second computer-readable medium.

4. A processing apparatus comprising:
a processor;
a memory device that is accessible by the processor;
a first entry stored on the memory device, wherein the first entry is stored in a locked state, and wherein the first entry includes a first reference identification; and
a second entry having a second reference identification that is linked to the first reference identification, wherein the second reference identification is different from the first reference identification.

5. A processing apparatus comprising:
a processor;
a memory device that is accessible by the processor;
a first entry having a first reference identification, wherein the first entry is stored on the memory device, and wherein the first entry is stored in a locked state; and
a second entry having a second reference identification that is linked to the first reference identification, wherein information in the second entry is different from information in the first entry.
